(19) United States
(12) Patent Application Publication
(10) Pub. No.: US 2006/0093423 A1
(43) Pub. Date: May 4, 2006

(54) Method and apparatus for controlling printing in inkjet printer

(75) Inventor: Chong-wan Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/191,028

(22) Filed: Jul. 28, 2005

(30) Foreign Application Priority Data
Oct. 29, 2004 (KR) 10-2004-0087058

(51) Int. Cl. B41J 29/38

(52) U.S. Cl. 400/629

(57) ABSTRACT

A method of controlling printing in an inkjet printer having a paper feeding apparatus, wherein the method includes the steps of determining whether print papers are double-fed by detecting a first print paper on which a first print data is to be printed, and a second print paper on which a second print data is to be printed, wherein both print papers are provided from a paper feeding apparatus, and reprinting the first print data on the second print paper when it is determined that the print papers are double-fed.

### CROSS-REFERENCE TO RELATED APPLICATIONS

This application claims the benefit under 35 U.S.C §119(a) of Korean Patent Application No. 10-2004-0087058, filed in the Korean Intellectual Property Office on Oct. 29, 2004, the entire disclosure of which is incorporated herein by reference.

### BACKGROUND OF THE INVENTION

1. Field of the Invention

The present invention relates to a method and apparatus for controlling printing in an inkjet printer. More particularly, the present invention relates to a method and apparatus for controlling printing in an inkjet printer when a print paper is transferred while being overlapped by another print paper.

2. Description of the Related Art

An inkjet printer typically includes a unit for preventing double feeding of a print paper, for example a friction pad, which provides a frictional force to another print paper that is overlapping a print paper to be printed. However, even where a print paper double feeding preventing unit is used, the print paper may still be transferred while being overlapped by another print paper, so that the print paper can be damaged.

In a printer, a typical paper feeding method includes a bin type and a cassette type mechanism for containing print papers according to the apparatus.

In the bin type feeding method, when the double feeding of a print paper occurs and a first print paper 1 is disposed above a second print paper 2 which is double-fed in a print direction A as shown in FIG. 1, the print data is printed on the first print paper 1 and the second print paper 2 can be discharged without being printed.

In contrast, in the cassette type feeding method, the first print paper 1 is disposed under the second print paper 2 which is double-fed in the print direction A as shown in FIG. 2. In this case, since part of the print data to be printed on the first print paper 1 is printed on the second print paper 2, both of the first and second print papers 1 and 2 are misprinted.

Accordingly, a need exists for a system and method for controlling the printing of double-fed print papers when the print papers are transferred while being overlapped.

### SUMMARY OF THE INVENTION

To solve the above and other problems, the present invention provides a method and apparatus for efficiently controlling the printing of double-fed print papers when the print papers are transferred while being overlapped from a cassette type paper feeding apparatus to a print portion of an inkjet printer.

According to an aspect of the present invention, a method is provided for controlling printing in an inkjet printer having a paper feeding apparatus wherein the method comprises the steps of determining whether the print papers are double-fed by detecting a first print paper on which a first print data is to be printed, and a second print paper on which a second print data is to be printed, wherein both print papers are being provided from the paper feeding apparatus, and printing or reprinting the first print data on the second print paper when it is determined that the print papers are double-fed.

The step of determining whether the print papers are double-fed comprises the steps of supplying a picked-up first print paper to a print area, detecting a front end of the first print paper, and detecting a front end of the second print paper disposed on the first print paper. In the step of printing the first print data on the second print paper, the first print data is printed on the second print paper when the front end of the second print paper is disposed in a top margin of the first print paper.

The step of detecting the front end of the second print paper comprises the steps of detecting an edge of the print paper, calculating a distance from the front end of the first print paper to the edge, and determining that the edge is the front end of the second print paper when the distance is shorter than a length of the first print paper in a lengthwise direction thereof.

The distance from the front end of the first print paper to the edge is measured by an encoder attached to a feeding roller.

The step of detecting the edge is performed using an edge detection sensor which is arranged at an upper location in a direction in which the print paper is transferred with respect to a printhead injecting ink onto the print paper.

The step of determining whether print papers are double-fed comprises the steps of supplying a picked-up first print paper to a print area, detecting a front end of the first print paper, printing the first print data on the first print paper, and detecting a front end of the second print paper disposed on the first print paper.

The step of printing comprises the steps of printing the second print data on the second print paper when the front end of the second print paper is detected and it is determined that the first print data is completely printed on the first print paper, and if not, reprinting the first print data on the second print paper.

According to another aspect of the present invention, an apparatus is provided for controlling printing in an inkjet printer having a paper feeding apparatus, wherein the printing controlling apparatus comprises an edge detection sensor for detecting edges of a first print paper on which a first print data is to be printed and edges of a second print paper on which a second print data is to be printed, wherein both print papers are provided from the paper feeding apparatus. The printing controlling apparatus further comprises a print control portion for printing or reprinting the first print data on the second print paper when it is determined that the second print paper is double-fed with the first print paper.

The print control portion is further provided to determine that the edge is a front end of the second print paper when a distance from a front end of the first print paper to the detected edge is shorter than a length of the first print paper in a lengthwise direction thereof.

The print control portion is still further provided to print the first print data on the second print paper when the front end of the second print paper is determined to be disposed in a top margin of the first print paper.

The print control portion is still further provided to print the second print data on the second print paper when the front end of the second print paper is detected and the first print data is completely printed on the first print paper, and if not, reprinting the first print data on the second print paper.

The apparatus further comprises an encoder attached to a feeding roller for supplying the print paper to measure a distance from the front end of the first print paper to the edge.

The edge detection sensor is arranged at an upper location in a direction in which the print paper is transferred with respect to a printhead injecting ink onto the print paper.

### BRIEF DESCRIPTION OF THE DRAWINGS

The above and other features and advantages of the present invention will become more apparent by describing in detail exemplary embodiments thereof with reference to the attached drawings, in which:

FIG. 1 is a view illustrating a paper double feeding phenomenon in a bin type paper feeding apparatus;

FIG. 2 is a view illustrating a paper double feeding phenomenon in a cassette type paper feeding apparatus;

FIG. 3 is a cross-sectional view of an inkjet printer adopting a print control method according to an embodiment of the present invention;

FIG. 4 is a block diagram illustrating a configuration of a print control apparatus adopting a print control method of an inkjet printer according to an embodiment of the present invention;

FIG. 5 is a flow chart for illustrating a print control method of an inkjet printer according to an embodiment of the present invention;

FIG. 6 is a flow chart for illustrating an embodiment 105A of the step 105 of FIG. 5 according to an embodiment of the present invention; and

FIG. 7 is a flow chart for illustrating a print control method of an inkjet printer according to another embodiment of the present invention.

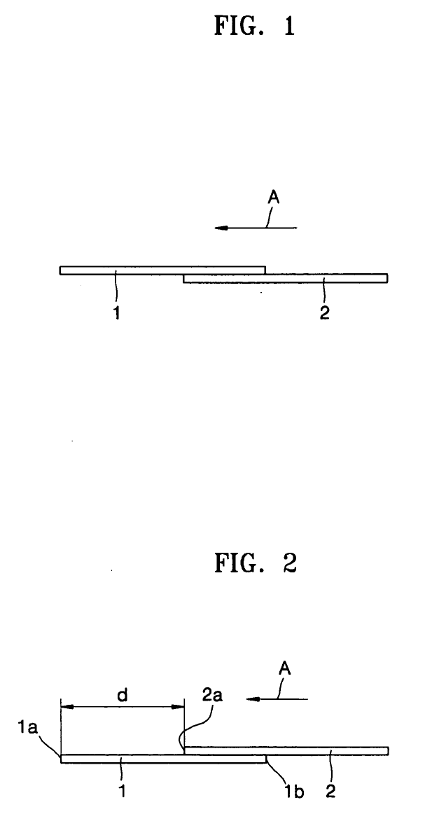

Throughout the drawings, like reference numerals will be understood to refer to like parts, components and structures.

### DETAILED DESCRIPTION OF THE EXEMPLARY EMBODIMENTS

In the accompanying drawings, the thickness of layers or areas are exaggerated for clarity in illustrating the associated examples.

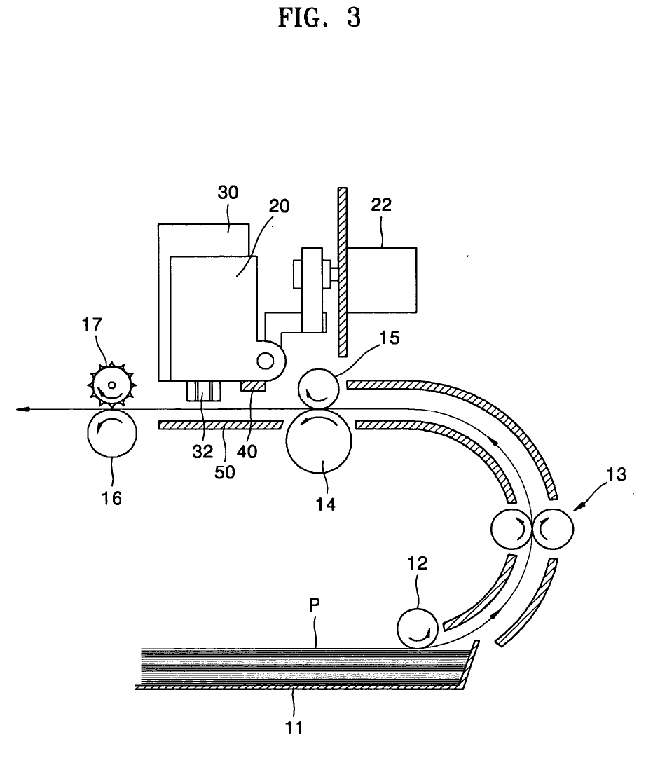

Referring to FIG. 3, the inkjet printer adopting a print control method according to an embodiment of the present invention comprises, along a direction in which a print paper P is transferred, a pickup roller 12 for picking up sheets of print paper P in a cassette 11 one by one, a transfer roller 13 for transferring a picked-up print paper, a feeding roller 14 and an idle roller 15 for receiving the print paper P from the transfer roller 13 and line-feeding the received print paper P, and a discharge roller 16 and a star wheel 17 for discharging a printed print paper.

The inkjet printer further comprises a carriage 20, a carriage motor 22, a platen 50 on which the print paper P is evenly placed, and a printhead 32 for injecting ink from an ink cartridge 30 onto the print paper P on the platen 50. The platen 50 and the printhead 32 are installed between the feeding roller 14 and the discharge roller 16. The ink cartridge 30 is mounted on the carriage 20, and the carriage 20 is moved by the carriage motor 22 in a widthwise direction of the print paper P.

The inkjet printer further comprises an edge detection sensor 40 for detecting an edge of the print paper P to be fed. The edge detection sensor 40 is installed on a lower surface of the carriage 20. The edge detection sensor 40 may be comprised of an optical sensor, including a light emitting portion and a light receiving portion. The edge detection sensor 40 can detect a front edge and a rear edge of the print paper P. The edge detection sensor 40 is preferably arranged at an upper location in a direction in which the print paper P is transferred with respect to the printhead 32.

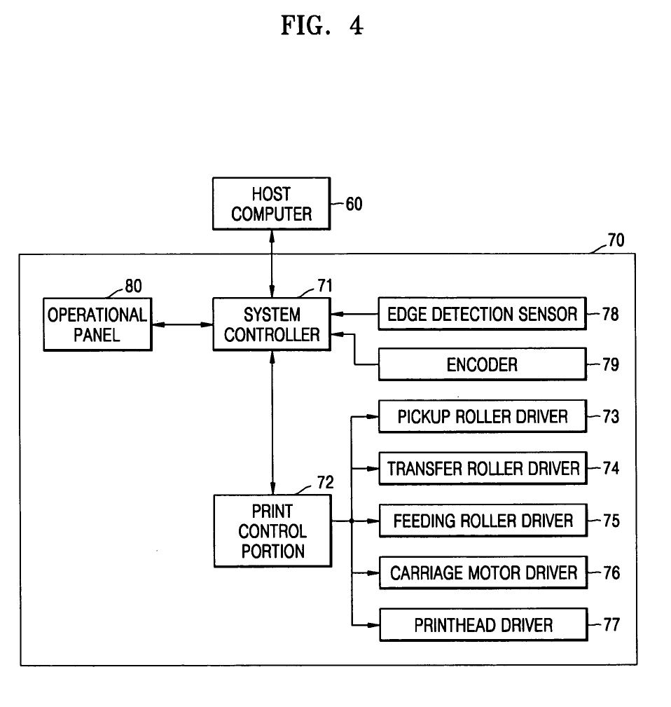

FIG. 4 is a block diagram illustrating a configuration of a print control apparatus adopting a print control method of an inkjet printer according to an embodiment of the present invention. Referring to FIG. 4, the print control apparatus comprises a host computer 60 and an inkjet printer 70. The inkjet printer 70 comprises a system controller 71, a print control portion 72, a pickup roller driver 73, a transfer roller driver 74, a feeding roller driver 75, a carriage motor driver 76, a printhead driver 77, the edge detection sensor 78, an encoder 79, and an operational panel 80.

The host computer 60 transfers print data created by a print driver (not shown) to the inkjet printer 70. The system controller 71 is provided for performing an overall control of the inkjet printer 70, and comprises a CPU of a microprocessor type, a ROM for storing fixed data such as a control program, and a RAM for storing print data.

The print control portion 72 is provided to drive the pickup roller driver 73, the transfer roller driver 74, the feeding roller driver 75, the carriage motor driver 76, and the printhead driver 77.

The edge detection sensor 78 comprises a light emitting portion for emitting light to the print paper P supplied onto the paten 50, and a light receiving portion for receiving light reflected from the print paper P. The print control portion 72 is provided to detect an edge of the print paper P from an optical output value of the edge detection sensor 78.

The encoder 79 is installed on an outer circumferential surface of a rotation shaft of the feeding roller 14 and measures a rotational angle of the feed roller 14, and further transfers a measured signal to the system controller 71.

The operational panel 80 comprises a key matrix and a display portion. The key matrix generates data according to a key pressed to operate the printer 70, and outputs the generated data to the system controller 71. The display portion displays an operational state of the printer 70 when the system controller 71 performs each of the print modes.

A method of controlling printing of an inkjet printer according to an embodiment of the present invention is described in greater detail below with reference to the accompanying drawings.

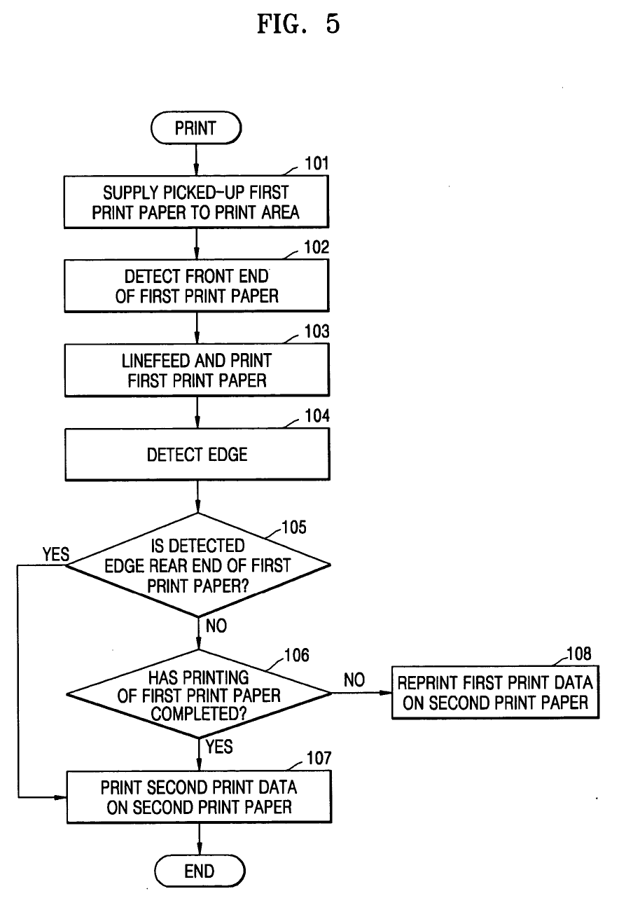

FIG. 5 is a flow chart for illustrating a print control method of an inkjet printer according to an embodiment of the present invention. Referring to FIGS. 2 through 5, when the host computer 60 is connected to the inkjet printer 70 and inputs a print command to the inkjet printer 70, the pickup roller 12 picks up the first print paper 1 and supplies the picked-up first print paper 1 to the feeding roller 14 via the transfer roller 13 at Step 101. The feeding roller 14 feeds the first print paper 1 to a print area between the platen 50 and the printhead 32.

The edge detection sensor 40 installed at the carriage 20 detects a front edge or end 1a of the first print paper 1 of FIG. 2 which enters the print area between the platen 50 and the printhead 32, and transmits a detection signal to the print control portion 72 at Step 102.

The print control portion 72 line-feeds the first print paper 1 into the print area and drives the printhead driver 77 according to the first print data from the host computer 60 to perform line printing at Step 103. Next, when the edge detection sensor 40 detects the edge again at Step 104, it is determined whether the edge is the rear end of the first print paper 1 which is being printed, or if it is the front end of the second print paper 2 which is being double-fed, at Step 105.

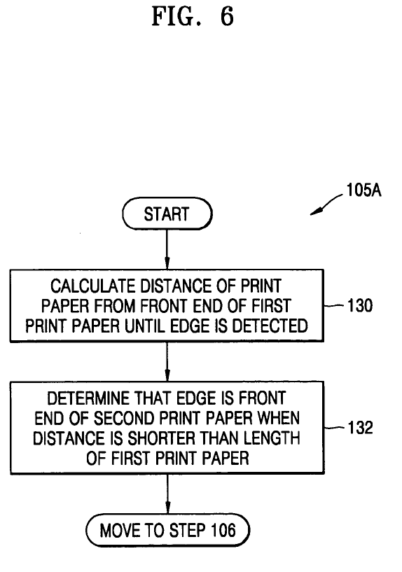

FIG. 6 is a flow chart for illustrating an embodiment 105A of the Step 105 of FIG. 5 to determine whether the edge is the rear end of the first print paper 1 which is being printed, or if it is the front end of the second print paper 2 which is being double-fed. Referring to FIG. 6, a distance “d” of FIG. 2 is calculated from the front end 1a of the first print paper 1 until the edge is detected at Step 130. The distance “d” can be measured using the encoder 79 installed on the outer circumferential surface of the rotation shaft of the feeding roller 14.

Next, the distance “d” is evaluated and when the distance “d” is shorter than the length of the first print paper 1 in the lengthwise direction thereof, the edge is determined to be the front end 2a of FIG. 2 of the second print paper 2 at Step 132. Otherwise, the edge is determined to be the rear end 1b of the first print paper 1.

Returning to Step 105 of FIG. 5, when the detected edge is determined to be the front end 2a of the second print paper 2, it is then determined whether the first print data is completely printed on the first print paper 1 at Step 106. For example, in Step 132, when the distance “d” between the front end 1a of the first print paper 1 and the front end 2a of the second print paper 2 is longer than the lengthwise distance of the first print data, it is determined whether the first print data is completely printed on the first print paper 1.

In Step 106, when it is determined that the first print data is completely printed on the first print paper 1 and the second print data to be printed on the second print paper 2 has been transferred from the host computer 60 to the system controller 71, the second print data is then printed on the second print paper 2 at Step 107.

In Step 106, when it is determined that the first print data is not completely printed on the first print paper 1, the first print data is reprinted on the second print paper 2 at Step 108.

Returning to Step 105, when the detected edge is determined to be the rear end of the first print paper 1, the second print data is printed on the second print paper 2 in a normal manner.

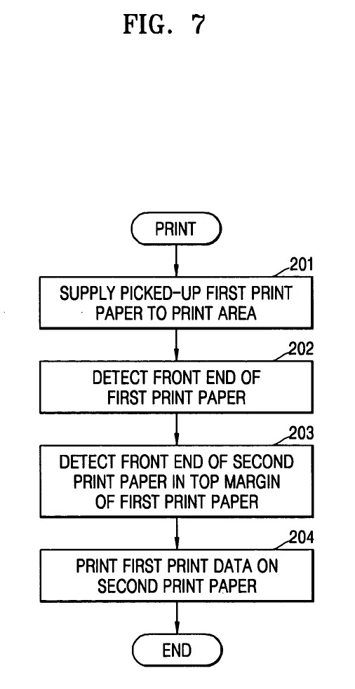

FIG. 7 is a flow chart for illustrating a print control method of an inkjet printer according to another embodiment of the present invention. Although in the above embodiment, the front end of the second print paper that is double-fed is detected after printing on the first print paper has begun, in another embodiment of the present embodiment, the front end of the second print paper can be detected when disposed in a top margin of the first print paper.

Referring to FIG. 7, when a print command from the host computer 60 connected to the inkjet printer 70 is input to the printer 70, the pickup roller 12 picks up the first print paper 1 and supplies the picked-up first print paper to the feeding roller 14 via the transfer roller 13 at Step 201. The feeding roller 14 feeds the received first print paper into the print area.

The edge detection sensor 40 installed at the carriage 20 detects the front edge or end 1 a of the first print paper 1 entering the print area between the platen 50 and the printhead 32, and transmits a detection signal to the print control portion 72 at Step 202.

When the edge detection sensor 40 detects the front end 2a of the second print paper 2 in the top margin of the first print paper 1 when the first print paper 1 is line-fed into the print area at Step 203, the print control portion 72 prints the first print data on the second print paper 2 at Step 204.

As described above, in the method and apparatus for controlling printing in an inkjet printer according to embodiments of the present invention, even when the double feeding of the print paper occurs, the original print data can be reprinted or new print data can be printed on the double-fed print paper according to the proceeding of printing the print data, such that an efficiency in printing of the printer can be improved.

While the invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of controlling printing in an inkjet printer having a paper feeding apparatus, the method comprising the steps of:
determining whether print papers are double-fed by detecting a first print paper on which a first print data is to be printed and a second print paper on which a second print data is to be printed, wherein both print papers are provided from a paper feeding apparatus; and
printing the first print data on the second print paper when it is determined that the print papers are double-fed.

2. The method as claimed in claim 1, wherein the step of determining whether print papers are double-fed comprises the steps of:
supplying a picked-up first print paper to a print area;
detecting a front end of the first print paper;
detecting a front end of the second print paper supplied with the first print paper; and
printing the first print data on the second print paper when the front end of the second print paper is disposed in a top margin of the first print paper.

3. The method as claimed in claim 2, wherein the step of detecting the front end of the second print paper comprises the steps of:
detecting an edge of a print paper;
calculating a distance from the front end of the first print paper to the edge; and
determining that the edge is the front end of the second print paper when the distance is shorter than a length of the first print paper in a lengthwise direction thereof.

4. The method as claimed in claim 3, wherein the distance from the front end of the first print paper to the edge is measured by an encoder attached to a feeding roller.

5. The method as claimed in claim 3, wherein the step of detecting the edge is performed using an edge detection sensor which is arranged at an upper location in a direction in which the print paper is transferred with respect to a printhead injecting ink onto the print paper.

6. The method as claimed in claim 1, wherein the step of determining whether print papers are double-fed comprises the steps of:
supplying a picked-up first print paper to a print area;
detecting a front end of the first print paper;
printing the first print data on the first print paper; and
detecting a front end of the second print paper supplied with the first print paper.

7. The method as claimed in claim 6, further comprising the steps of:
printing the second print data on the second print paper when the front end of the second print paper is detected and it is determined that the first print data is completely printed on the first print paper; and
reprinting the first print data on the second print paper when the front end of the second print paper is detected and it is determined that the first print data is not completely printed on the first print paper.

8. The method as claimed in claim 6, wherein the step of detecting the front end of the second print paper comprises the steps of:
detecting an edge of a print paper;
calculating a distance from the front end of the first print paper to the edge; and
determining that the edge is the front end of the second print paper when the distance is shorter than a length of the first print paper in a lengthwise direction thereof.

9. The method as claimed in claim 8, wherein the distance from the front end of the first print paper to the edge is measured by an encoder attached to a feeding roller.

10. The method as claimed in claim 8, wherein the step of detecting the edge is performed using an edge detection sensor which is arranged at an upper location in a direction in which the print paper is transferred with respect to a printhead injecting ink onto the print paper.

11. An apparatus for controlling printing in an inkjet printer having a paper feeding apparatus, the printing controlling apparatus comprising:
an edge detection sensor, for detecting edges of a first print paper on which a first print data is to be printed and edges of a second print paper on which at least one the first print data and a second print data is to be printed, wherein both print papers are provided from a paper feeding apparatus; and
a print control portion, for printing the first print data on the second print paper when it is determined that the second print paper is double-fed with the first print paper.

12. The apparatus as claimed in claim 11, wherein the print control portion is configured to determine that a detected edge is a front end of the second print paper when a distance from a front end of the first print paper to the detected edge is shorter than a length of the first print paper in a lengthwise direction thereof.

13. The apparatus as claimed in claim 12, wherein the print control portion is configured to print the first print data on the second print paper when the front end of the second print paper is determined to be disposed in a top margin of the first print paper.

14. The apparatus as claimed in claim 12, wherein the print control portion is configured to print the second print data on the second print paper when the front end of the second print paper is detected and the first print data is completely printed on the first print paper and reprint the first print data on the second print paper when the front end of the second print paper is detected and the first print data is not completely printed on the first print paper.

15. The apparatus as claimed in claim 11, further comprising:
a feeding roller, for supplying the print paper; and
an encoder attached to the feeding roller supplying the print paper, for measuring a distance from the front end of the first print paper to the edge.

16. The apparatus as claimed in claim 8, wherein the edge detection sensor is arranged at an upper location in a direction in which the print paper is transferred with respect to a printhead injecting ink onto the print paper.
